(19) United States
(12) Patent Application Publication
(10) Pub. No.: US 2015/0362131 A1
(43) Pub. Date: Dec. 17, 2015

(54) FLEXIBLE DISCHARGE PIPE FOR A PUMP SYSTEM

(71) Applicant: WEIR CANADA, INC., Mississauga (CA)

(72) Inventors: Richard HAIGHT, Mississauga (CA); Peter PAVLIN, Mississauga (CA)

(21) Appl. No.: 14/736,873

(22) Filed: Jun. 11, 2015

Related U.S. Application Data
(60) Provisional application No. 62/010,686, filed on Jun. 11, 2014.

(51) Int. Cl. F17D 1/14

(52) U.S. Cl. CPC F17D 1/14

(57) ABSTRACT

According to embodiments described in the specification, a pump system is provided for use in a body of fluid having a shore. The pump system includes: a pump support; and a discharge pipe coupled to the pump support at a first end and to the shore at a second end, the discharge pipe including at least one segment of a first material and at least one segment of a second material, and having an expanded position for increasing a distance between the first and second ends, and a collapsed position for reducing the distance between the first and second ends. The discharge pipe is configured for accommodating lateral forces applied to the pump system by transitioning between the expanded and collapsed positions in response to the lateral forces.

### CROSS-REFERENCE TO RELATED APPLICATION

This application claims priority from U.S. provisional application No. 62/010,686, filed Jun. 11, 2014, the entire contents of which is incorporated herein by reference.

### TECHNICAL FIELD

The specification relates in general to pump systems, and in particular, to a discharge pipe for a pump system.

### BACKGROUND OF THE DISCLOSURE

Pump systems such as those including pumps mounted on barges may be used in mining and related activities. Such systems may be deployed in bodies of fluid such as tailings ponds, process water ponds and the like, whose water levels and shore geometry may change over the course of a year. Since the barges float on the surface of the body of fluid, the barges may rise or fall as the water level changes. The rising and falling of the barges may result in the distance between the barges and the shore of the body of fluid being increased or decreased. In some cases, the barges may be fixed to the shore via discharge piping or other hardware, in which case changes in the distance between the shore and the barges may impose undesirable stress on the system.

In addition, some systems may be operated by maintaining a target distance between the barges and the shore. Maintaining the target distance may require that the length of the piping and other hardware connecting the barges to the shore be adjusted from time to time. Such adjustments may require the operation of the barges to be interrupted, which may require other processes that rely on the operation of the barges to also be interrupted.

### SUMMARY

In a first aspect, there is provided a pump system for use in a body of fluid having a shore. The pump system includes: a pump support; and a discharge pipe coupled to the pump support at a first end and to the shore at a second end, the discharge pipe including at least one segment of a first material and at least one segment of a second material, and having an expanded position for increasing a distance between the first and second ends, and a collapsed position for reducing the distance between the first and second ends. The discharge pipe is configured for accommodating lateral forces applied to the pump system by transitioning between the expanded and collapsed positions in response to the lateral forces.

In certain embodiments, the discharge pipe includes a body defining a longitudinal axis, and an expansion member connected to the body. The expansion member has at least one segment that does not contain the longitudinal axis.

In certain embodiments, the body includes the at least one segment of the first material, and the expansion member includes the at least one segment of the second material.

In certain embodiments, the expansion member includes first and second segments connected to the body perpendicularly to the longitudinal axis and joined by a third segment parallel to the longitudinal axis.

In certain embodiments, the first and second segments are made of the second material, and the third segment is made of the first material.

In certain embodiments, the first and second segments are made of the first material, and the third segment is made of the second material. The body includes segments of the second material upstream and downstream of the expansion member.

In certain embodiments, the body includes a further section of the second material.

In certain embodiments, the pump support further includes at least one pump barge supporting at least one pump and coupled to a header barge.

In certain embodiments, the pump support further includes a header pipe supported by the header barge for connection to the discharge pipe and to the at least one pump.

In certain embodiments, the pump support further includes an additional header pipe supported by the header barge, and a plurality of pump barges supporting a plurality of pumps and coupled to the header barge; at least one of the pumps for connection to the header pipe, and at least one other of the pumps for connection to the additional header pipe.

In certain embodiments, the pump system further includes an additional discharge pipe for connection to the additional header pipe.

In certain embodiments, the additional discharge pipe further includes an additional expansion member.

In certain embodiments, the pump support further includes at least one mooring element coupled to the header barge.

In certain embodiments, the at least one mooring element further includes a spud slideably supported by a spud pocket coupled to the header barge.

In certain embodiments, the second material has greater flexibility than the first material.

In certain embodiments, the first material is selected from the group consisting of: steel, aluminum, polyvinyl chloride (PVC), high-density polyethylene (HDPE), and polypropylene.

In certain embodiments, the second material is selected from the group consisting of: acrylonitrile butadiene styrene (ABS), polyurethane, polytetrafluoroethylene (PTFE), nitrile, neoprene, and rubber.

Other aspects, features, and advantages will become apparent from the following detailed description when taken in conjunction with the accompanying drawings, which are a part of this disclosure and which illustrate, by way of example, principles of the inventions disclosed.

### DESCRIPTION OF THE FIGURES

The accompanying drawings facilitate an understanding of the various embodiments.

FIG. 1 depicts an isometric view of a pump system, in accordance with this disclosure;

FIG. 2 depicts another isometric view of the pump system of FIG. 1, in accordance with this disclosure;

FIG. 3 depicts a side elevational view of the pump system of FIG. 1, in accordance with this disclosure;

FIG. 4 depicts a cross section of a pump barge in the pump system of FIG. 1, in accordance with this disclosure;

FIGS. 5A, 5B and 5C depict an alternative expansion member for the discharge pipe of the pump system of FIG. 1 in three positions, in accordance with this disclosure;

FIG. 6 depicts another expansion member for the discharge pipe of the pump system of FIG. 1, in accordance with this disclosure;

FIG. 7 depicts an isometric view of another pump system, in accordance with this disclosure; and

FIG. 8 depicts a side elevational view of the pump system of FIG. 7, in accordance with this disclosure.

### DETAILED DESCRIPTION OF THE EMBODIMENTS

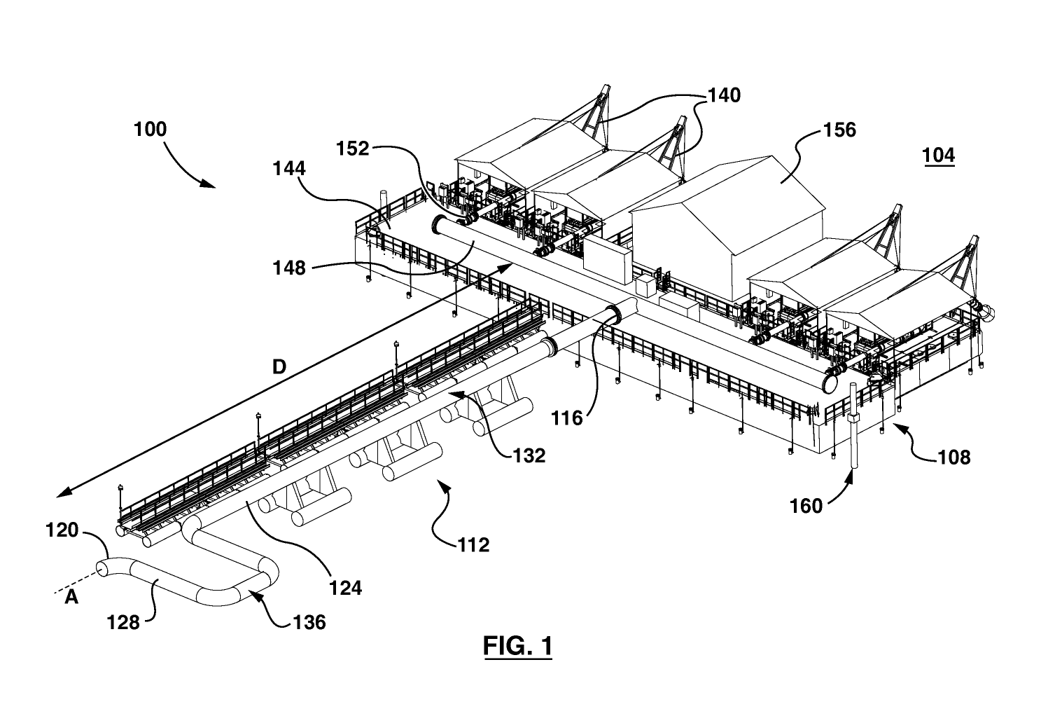

FIG. 1 depicts a pump system 100 for use in a body of fluid 104 having a shore (not shown). The body of fluid 104 can contain any one of, or any combination of, used or unused process water, treated wastewater effluent, mineral flotation tailings, slurry and the like, resulting from mining operations and related activities. The pump system 100 is operated to reclaim fluid (e.g. water) from the body of fluid 104 and deliver the reclaimed fluid to other processes.

The pump system 100 includes a pump support 108 and a discharge pipe 112 coupled to the pump support 108 at a first end 116 and to the shore at a second end 120. The connection to the shore at the second end 120 is not necessarily a connection directly to the terrain forming the shore, but rather may be a connection to further piping or equipment (not shown) mounted on the shore. Such further piping or equipment may be fixed on the shore, or may be movable in relation to the shore.

The discharge pipe 112, as will be discussed in further detail below, includes at least one segment of a first material 124, and at least one segment of a second material 128. In general, a segment made of the second material 128 may have greater flexibility than a segment made of the first material 124. Therefore, in some embodiments, the second material 128 may have greater flexibility (e.g. a lower stiffness) than the first material 124. The flexibility of each of the first material 124 and the second material 128 represents the degree of deformation of which the respective materials are capable. The flexibility of each of the first material 124 and the second material 128 can be characterized as a ratio of a bend radius of the respective material to a diameter of the respective material. The bend radius employed in the above-mentioned ratio is the smallest internal radius to which a segment (of any length) of the material can be bent without suffering structural damage or failure (e.g. collapsing or kinking). Thus, a material with a ratio of 10:1 is more flexible than a material with a ratio of 50:1.

An embodiment provides that the second material 128 has a bend radius to diameter ratio in a range of about 10:1 to about 50:1. In other embodiments, the second material 128 has a bend radius to diameter ratio in a range of above 1:1 and below 10:1. In further embodiments, the second material 128 has a bend radius to diameter ratio above about 50:1.

The flexibility of the first material 124 can be selected as a factor of the flexibility of the second material 128 (e.g. the ratio of the second material 128). An embodiment provides that the first material 124 has a stiffness of about ten times to about one hundred times the stiffness of the second material 128. Thus, in embodiments in which the flexibility of the second material 128 is defined by a ratio of about 10:1, the ratio for the first material 124 can be between 100:1 and 1000:1. In other embodiments, the first material 124 has a stiffness in a range above one and below ten times the stiffness of the second material 128. In yet another embodiment, the first material 124 has a stiffness above one hundred times the stiffness of a segment of the second material 128.

The flexibility (e.g. the ratio described above) of each of the first material 124 and the second material 128 is influenced by the composition of the respective material, as well as the geometry of the respective material (for example, one or more of the cross-sectional shape, wall thickness, and diameter or equivalent measure).

For example, the composition of the first material 124 may include any suitable metal or combinations of metals, such as stainless steel, carbon steel, aluminum and the like. The composition of the first material 124 can also include suitable plastic or combination of plastics, such as polyvinyl chloride (PVC), high-density polyethylene (HDPE), polypropylene, and the like. In other examples, the composition of the first material 124 can also include composite materials, such as a polymer (e.g. epoxy, polyester and the like) reinforced with fibers and particles such as aramid fibers, carbon fiber, nanoparticles, and the like. In other embodiments, the first material 124 can include any suitable combination of the materials above or other suitable materials. For example, the first material 124 can include a plastic material (e.g. HDPE) reinforced with metal rings (e.g. steel).

The geometry of the first material 124 can include an annular cross-section having an outer diameter in a range of between sixteen inches and forty-two inches. In other embodiments, the outer diameter of the first material 124 can be in a range of above zero and below sixteen inches. In further embodiments, the outer diameter of the first material 124 can be above forty-two inches.

In an embodiment, the wall thickness of the first material 124 can be in a range of between one quarter inch and one inch. In other embodiments, the wall thickness of the first material 124 can be in a range of above zero to one quarter inch. In further embodiments, the wall thickness of the first material 124 can be above one inch.

An exemplary embodiment provides that the first material 124 is a steel pipe having an annular cross-section, a wall thickness of three-eighths of an inch, and an outer diameter of sixteen inches.

In yet another example, the first material 124 is a steel pipe having an annular cross-section, a wall thickness of one half inch, and an outer diameter of forty-two inches.

In still another example, the first material 124 is an HDPE pipe having an annular cross-section, a wall thickness of about one and a half inches, and an outer diameter of about twenty-four inches.

A segment made of the first material 124 is provided by selecting a length of the first material 124, for example, based on the distance between the pump support 108 and the shore. For example, a segment of the first material 128 may have a length in a range of about fifty feet to about two hundred feet. In other embodiments, a segment of the first material 128 may have a length in a range of above zero to below about fifty feet. In still other embodiments, a segment of the first material 128 may have a length of above about two hundred feet.

The composition of the second material 128 may include any suitable resiliently flexible material, such as rubber (whether natural rubber, synthetic rubber, or a combination thereof). Other examples of the composition of the second material 128 include plastics, such as thermoset plastics, thermoplastics, acrylonitrile butadiene styrene (ABS), polyurethane, polytetrafluoroethylene (PTFE), nitrile, neoprene and the like. The composition of the second material 128 can also include metals, such as aluminum. The composition of the second material 128 can also include composite materials, fiber-reinforced materials, particle reinforced materials, and combinations of the above-mentioned materials. An embodiment of the second material provides a helical-wound metal band encased in a polymer such as rubber.

The geometry of the second material 128 can include an annular cross-section having an outer diameter in a range of between sixteen inches and forty-two inches. In other embodiments, the outer diameter of the second material 128 can be in a range of above zero and below sixteen inches. In further embodiments, the outer diameter of the second material 128 can be above forty-two inches.

In an embodiment, the wall thickness of the second material 128 can be in a range of between one inch and two inches. In other embodiments, the wall thickness of the second material 128 can be in a range of above zero to one inch. In further embodiments, the wall thickness of the second material 128 can be above two inches.

An exemplary embodiment provides that the second material 128 is a fiber-reinforced rubber hose having an annular cross-section, an outer diameter of about sixteen inches, and a wall thickness of about one inch.

In yet another exemplary embodiment, the second material 128 is a rubber hose reinforced with fiber wrappings and metal (e.g. steel) rings, having an annular cross section, an outer diameter of about forty-two inches, and a wall thickness of about one and a half inches.

A segment made of the second material 128 is provided by selecting a length of the second material 128. For example, the length of the second material 128 can be selected based on the bending radius of the second material 128 and the desired change in distance, described below, between the pump support 108 and the shore to be provided by bending of the segment (or segments) of the discharge pipe 112 made of the second material 128. For example, a segment of the second material 128 may have a length in a range of about five feet to about twenty feet. In other embodiments, a segment of the second material 128 may have a length in a range of above zero and below about five feet. In further embodiments, a segment of the second material 128 may have a length of above about twenty feet.

The discharge pipe 112 has an expanded position for increasing a distance “D” between the first end 116 and the second end 120. The discharge pipe 112 also has a collapsed position for reducing the distance D between the first end 116 and the second end 120. The discharge pipe 112 is configured to accommodate lateral forces—that is, forces in a plane parallel to a surface of the body of fluid 104 in which the pump system 100 is deployed—applied to the pump system 100 by transitioning between the expanded and collapsed positions in response to those lateral forces.

The discharge pipe 112 includes a body 132 defining a longitudinal axis “A” that, as will be apparent from FIG. 1, is contained within the body 132. The discharge pipe 112 also includes an expansion member 136 connected to the body 132. The expansion member 136 includes at least one segment of pipe that does not contain the longitudinal axis A. That is, the expansion member 136 includes at least one segment that deviates from the path of the body 132 defining the longitudinal axis A, although the expansion member 136 as a whole may then return to the longitudinal axis A, for instance at the second end 120 seen in FIG. 1. As will be described below, the expansion member 136 allows for the above-mentioned transitioning between expanded and collapsed positions, by providing greater lateral flexibility than the body 132, particularly in a direction generally parallel to the longitudinal axis A.

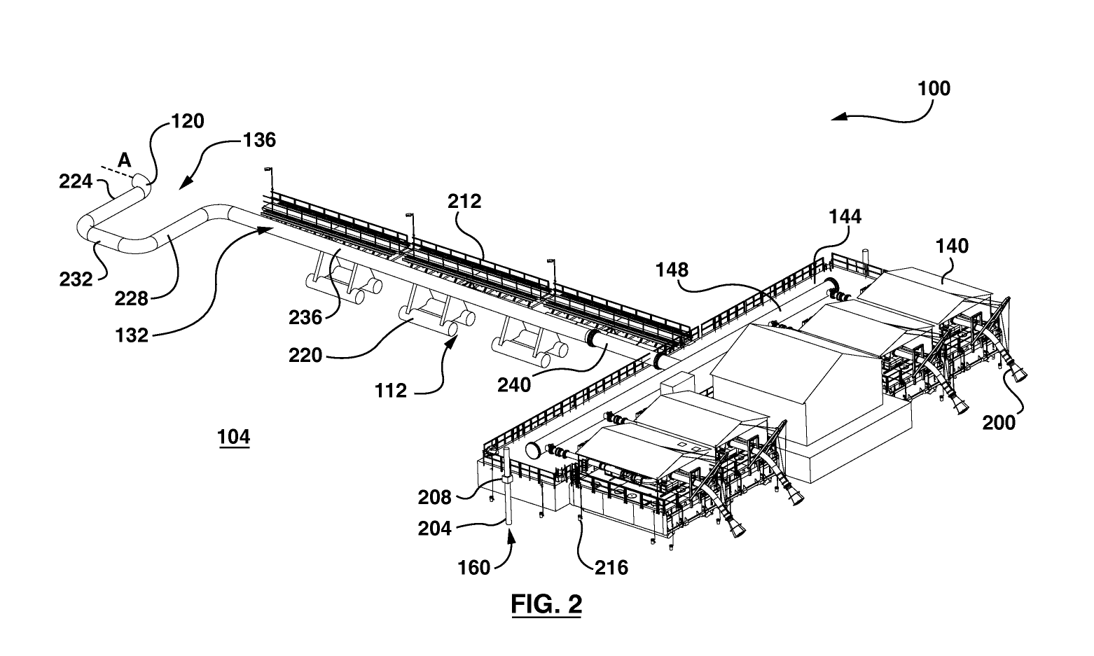

The discharge pipe 112 may be used in conjunction with a wide variety of pump supports 108. In the present example, the pump support 108 includes at least one pump barge 140 supporting at least one pump for recovering water or other fluids from the body of fluid 104. In the example shown in FIG. 1, four pump barges 140 are shown, each supporting one pump. Referring briefly to FIG. 2, another view of the pump barges 140 is shown in which pump suction hoses 200 of each of the pumps are more clearly visible.

Returning to FIG. 1, the pump barges 140 are coupled to a header barge 144, which supports at least one header pipe 148. The header pipe 148 is for connection to the pumps via discharge lines 152, and is also for connection to the discharge pipe 112. Thus, fluid recovered from the body of fluid by the pumps on the pump barges 140 may be transported via the discharge lines 152 to the header pipe 148, and then into the discharge pipe 112 for transport to the shore.

The header barge 144 may include other components, such as an electrical house 156 containing the appropriate mechanisms for controlling the flow rate of each of the pumps. In some examples, the electrical house 156 may be mounted on a separate barge coupled to the header barge 144. In addition, the pump system 100 may include at least one mooring element 160 coupled to the header barge 144. In the present example, as shown in FIG. 2, the at least one mooring element 160 includes a spud 204 slideably supported by a spud pocket 208 coupled to the header barge. Two spuds 204, on opposite sides of the header barge 144, are shown in the present embodiment. However, in other embodiments a wide variety of configurations of spuds 204 or other types of mooring element 160 can be employed (e.g. cables and winches).

Still referring to FIG. 2, pump system 100 may include a walkway 212 extending from the header barge 144 towards the shore (not shown). The walkway 212, the header barge 144, and the pump barges 140 may have a plurality of de-icing agitators 216 suspended therefrom into the body of fluid 104 to reduce or eliminate the build-up of ice around the pump system 100 in low temperatures. Further, the discharge pipe 112 may carry additional de-icing agitators (not shown).

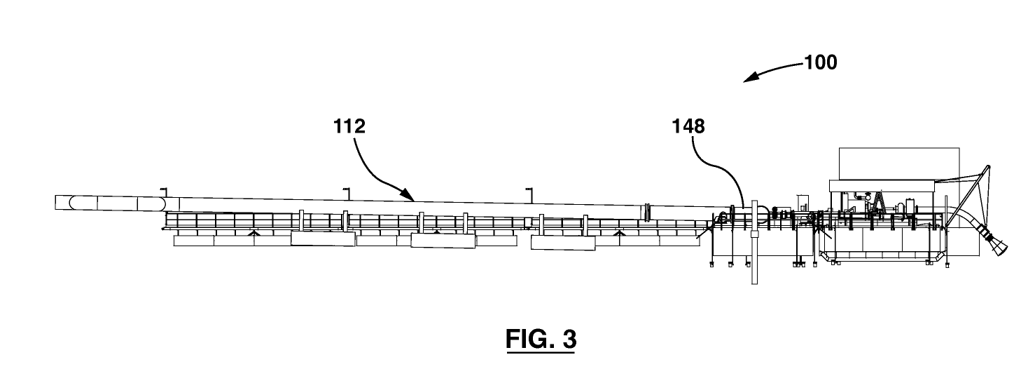

The discharge pipe 112, in some examples, can include floats 220 or other supporting structures to support the discharge pipe 112 on the surface of the body of fluid 104, and in some embodiments to raise the level of the discharge pipe 112 above that of the header pipe 148. As seen in FIG. 3, the discharge pipe 112 may also be angled upwards from the header pipe 148 towards the shore to facilitate draining of the pump system 100. In some embodiments, the angle of the discharge pipe 112 may be maintained by anchoring the discharge pipe 112 on shore at a point higher than the highest expected level of the body of fluid 104.

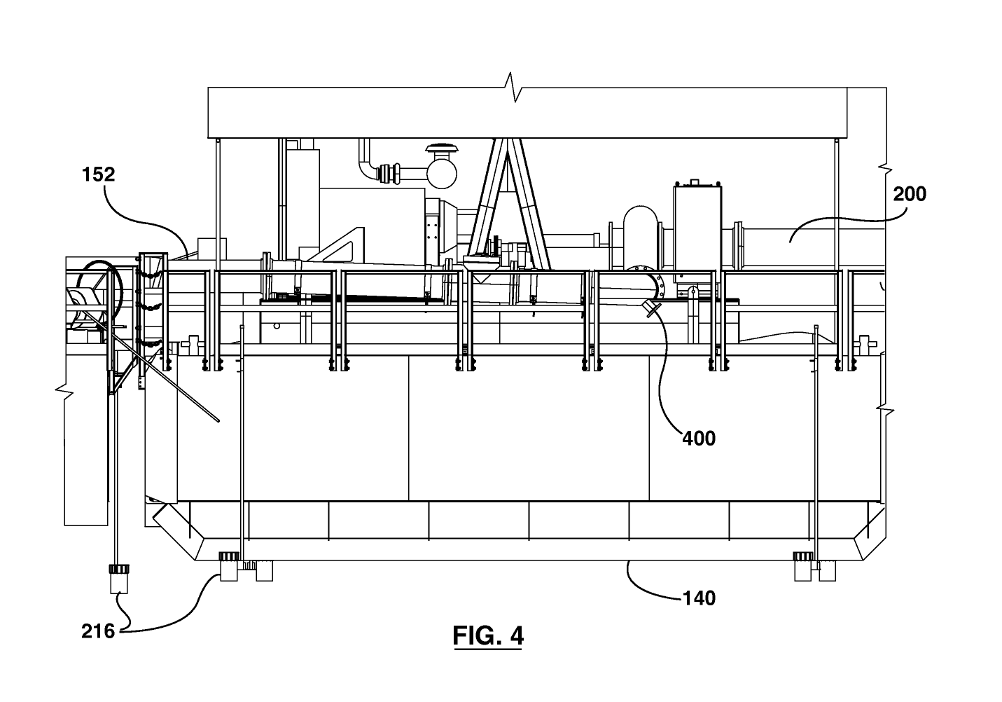

Turning to FIG. 4, an example draining mechanism is shown. FIG. 4 depicts a partial view of one of the pump barges 140, showing a portion of the pump suction hose 200, a portion of the discharge line 152 and several of the de-icing agitators 216. In addition, the pump barge 140 may include a drainage valve 400 that can be opened to allow draining of the discharge pipe 112, the header pipe 148, and the discharge line 152 (which, as seen in FIG. 4, may also be angled upwards to facilitate draining).

Returning to FIG. 1, the expansion member 136 of the discharge pipe 112 will now be described in greater detail. As mentioned earlier, the expansion member 136 deviates from the longitudinal axis A by including at least one segment of pipe that does not contain the longitudinal axis A. Stated another way, the expansion member 136 comprises a length of pipe that is greater than the distance between the ends of the expansion member 136 where the expansion member 136 is joined to the body 132. A wide variety of configurations are possible for the expansion member 136, and in general the expansion member 136 is comprised of segments of pipe that are arranged and made of suitable materials such that their positions relative to one another can be altered by the application of forces to the pump system 100, particularly lateral forces such as forces parallel to the longitudinal axis A.

The origin of such lateral forces is not particularly limited, and may vary depending on the operational environment of the pump system 100. For example, the body of fluid 104 may experience significant rise and fall of its surface over the course of a year (for example, a rise and fall of several metres). In some examples, pump support 108 is fixed to a bottom of the body of fluid 104 by mooring elements 160 and thus may be permitted to move vertically as the level of the body of fluid rises and falls. Particularly in embodiments where the discharge pipe 112 is connected to fixed equipment on shore, such vertical movement may exert lateral stress on the discharge pipe 112, as the ends 116 and 120 of the discharge pipe 112 are coupled to fixed objects that are moving away from each other or towards each other. Other operational situations in which lateral forces are applied to pump system 100 will now occur to those skilled in the art. An additional example will be discussed further below in connection with a variant of pump system 100 having two discharge pipes 112.

In the example shown in FIGS. 1 and 2, the expansion member 136 is U-shaped, or horseshoe-shaped. More specifically, as shown in FIG. 2, the expansion member 136 includes a first segment 224 and a second segment 228 connected to the body perpendicularly to the longitudinal axis A. It will now be apparent that although the expansion member 136 terminates at the second end 120 of the discharge pipe 112, in other examples the discharge pipe 112 may continue upstream of the expansion member 136. In effect, in such examples the expansion member 136 may be connected to the body 132 in such a way as to divide the body 132 into two portions. The first and second segments 224 and 228 are joined together by a third segment 232 parallel to the longitudinal axis A. The first and second segments 224 and 228 may be joined to the third segment 232, as well as to the body 132, by elbow joints.

In the present example, the first and second segments 224 and 228 are made of the above-mentioned second material 128 (e.g. rubber), while the elbow joints and at least a portion of the body 132 are made of the above-mentioned first material 124 (e.g. steel). Thus, when lateral forces are applied to pump system 100, the first and second segments 224 and 228 may deform, allowing the distance between the ends of the expansion member 136 to be decreased or increased, and thus increasing or decreasing the distance between the first and second ends 116 and 120 of the discharge pipe 112.

As seen in FIG. 2, the body 132 may include at least one segment 236 made of the first (that is, less flexible) material 124. In some examples, the body 132 may be made entirely of the first material. In other examples, however, such as that shown in FIG. 2, the body 132 may also include a segment 240 made of the second (that is, more flexible) material 128 (e.g. at or near the first end 116 of the discharge pipe 112).

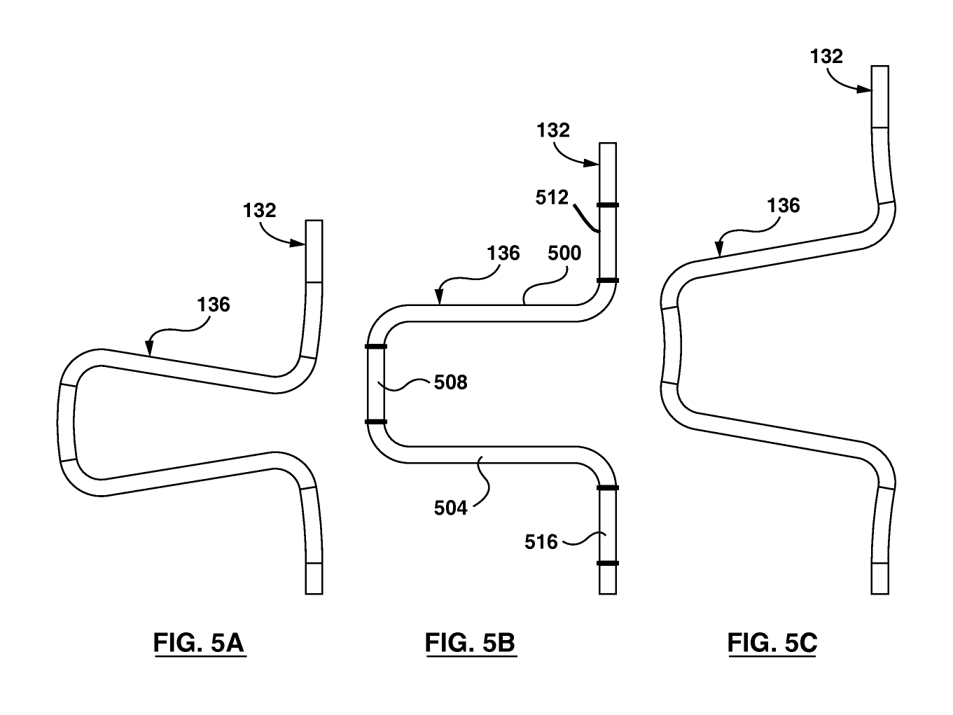

Turning to FIGS. 5A, 5B and 5C, another example of the expansion member 136 is shown. FIG. 5A shows the expansion member 136 in the collapsed position, while FIG. 5B shows the expansion member 136 in a neutral position (in transition between the collapsed and expanded positions) and FIG. 5C shows the expansion member 136 in the expanded position. As seen in FIG. 5B, the expansion member 136 includes a first segment 500, a second segment 504, and a third segment 508. In the neutral position, which is the position assumed by the expansion member 136 in the absence of lateral forces on the pump system 100, the first and second segments 500 and 504 are connected to the body 132 generally in a perpendicular orientation. In addition, the first and second segments 500 and 504 are joined to each other by the third segment 508.

The first and second segments 500 and 504 in this example are made of the first material 124, and thus have limited flexibility, or no flexibility. The third segment 508, on the other hand, is made of the second material 128, and therefore has greater flexibility than the first and second segments 500 and 504. In addition, the body 132 may include segments 512 and 516 upstream and downstream, respectively, of the expansion member 136. The segments 512 and 516 are also made of the second material. As a result, the application of lateral force, such as a force parallel to the longitudinal axis A, leads to deformation of the segments 508, 512 and 516, as shown in FIGS. 5A and 5C.

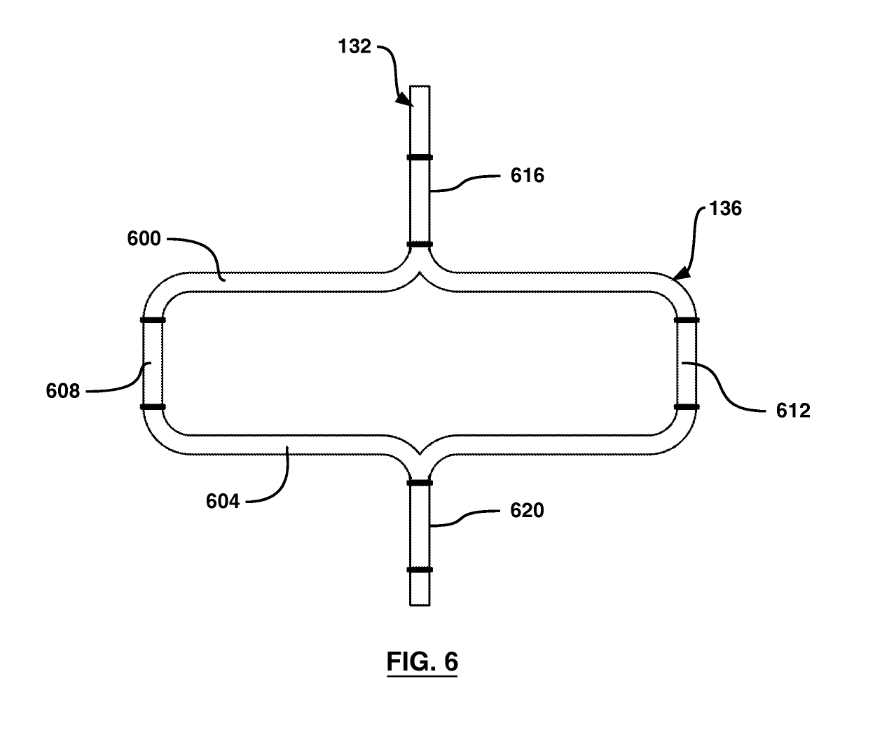

Variations to the pump system 100 are contemplated, in addition to those discussed above. Specifically, a variety of configurations are possible for the expansion member 136 in addition to those described above. For example, expansion member can have the configuration shown in FIG. 6, including a first segment 600 and a second segment 604 each made of the second (more flexible) material 128 and joined perpendicularly to the body 132, as well as a third segment 608 and a fourth segment 612 each made of the first (less flexible) material. The body 132 may also include segments 616 and 620 upstream and downstream of the expansion made of the second material, although these may also be omitted in favour of segments of the first material. In further embodiments, the first segment 600 and the second segment 604 can be made of the first (less flexible) material 124, while the third segment 608 and the fourth segment 612 (as well as the additional segments 616 and 620, when those segments are included) can be made of the second (more flexible) material 128.

Other configurations for the expansion member 136 include a helical or coiled pipe disposed along the longitudinal axis A, at least a portion of a length of the helical pipe being made of the second material. Still another example configuration of the expansion member 136 includes a plurality of segments arranged in a zig-zag pattern, in which at least some of the segments are made of the second material.

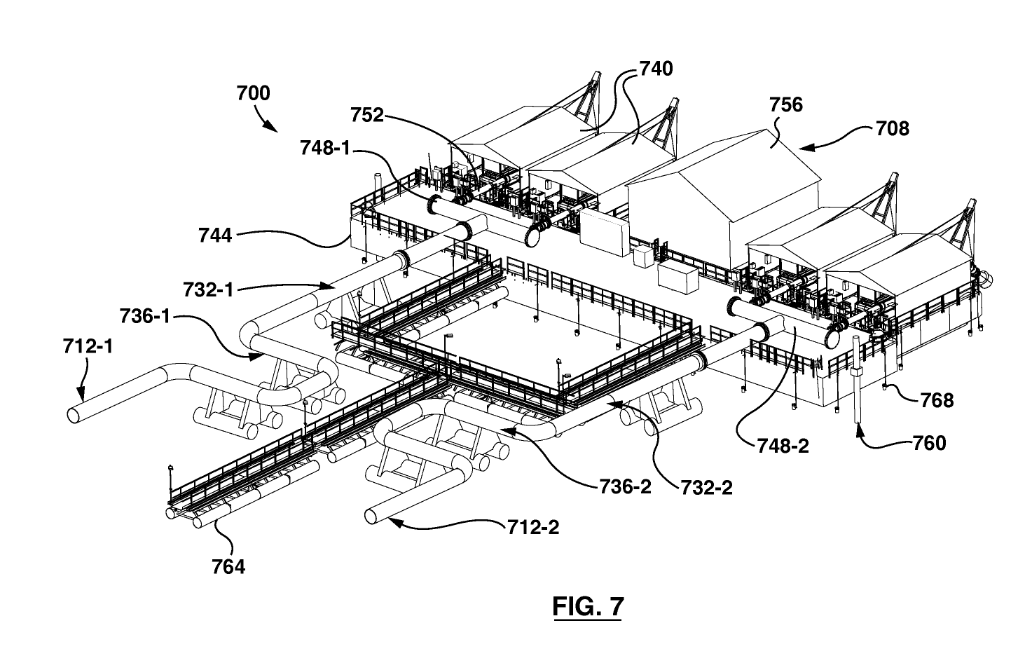

Referring now to FIG. 7, in some embodiments two or more discharge pipes may be provided in a pump system. FIG. 7 depicts a system 700 for use in a body of fluid 704 having a shore (not shown). The body of fluid 704 may be as described above in connection with the body of fluid 104. The system 700 includes a pump support 708 and a pair of discharge pipes 712-1 and 712-2 (collectively referred to as discharge pipes 712). It is contemplated that in other embodiments, such as those in which the pump support 708 has a greater length, additional discharge pipes 712 may be provided. Each of the discharge pipes 712-1 and 712-2 may be coupled to the pump support 708 at a first end and to the shore at a second end, as described above in connection with the discharge pipe 112.

As also discussed above in connection with the discharge pipe 112, each of the discharge pipes 712-1 and 712-2 includes at least one segment of a first material and at least one segment of a second material. The discharge pipes 712-1 and 712-2 include, respectively, bodies 732-1 and 732-2 and expansion members 736-1 and 736-2. The configuration of each of the discharge pipes 712-1 and 712-2 is not particularly limited, and can take any of the forms discussed herein. In the example shown in FIG. 7, both of the discharge pipes 712-1 and 712-2 have the configuration shown in FIGS. 5A, 5B and 5C as discussed above.

The pump support 708 can include a plurality of pump barges 740, which may be as described above in connection with the pump barges 140, coupled to a header barge 744. The header barge 744 may be as described above in connection with the header barge 144, with the exception that rather than supporting a single header pipe, the header barge 744 supports a pair of header pipes 748-1 and 748-2. In other embodiments, the header barge 744 may include additional header pipes. The pumps mounted on the pump barges 740 may be connected to the header pipes 748-1 and 748-2 by discharge lines 752. The header barge may also support an electrical house 756, and may include mooring elements 760, as described above in connection with the electrical house 156 and the mooring elements 160.

In contrast to the pump system 100, a subset of the pump barges 740 (two, in the present embodiment) may be connected to the header pipe 748-1, while the remaining subset of the pump barges 740 are connected to the header pipe 748-2. The header pipes 748-1 and 748-2 are connected in turn to the discharge pipes 712-1 and 712-2, respectively. Thus, two independent fluid supply systems are established, and two of the pump barges 740 can be disabled, for example to conduct maintenance on the discharge pipe 712-1, while the other two pump barges 704 can continue operating, since their output is collected in the discharge pipe 712-2.

The arrangement shown in FIG. 7 may allow, for example, the body 732-1 of the discharge pipe 712-1 to be disconnected from on-shore equipment and extended or reduced in length by adding or removing sections of pipe, and then reconnected to the on-shore equipment. During such maintenance, the pump barges 740 connected to the discharge pipe 712-2 may continue to operate, and the expansion members 736-1 and 736-2 may expand and contract as needed to accommodate the differences in length between the two discharge pipes 712. Once the discharge pipe 712-1 has been reconnected following adjustment of its length, the same procedure may be repeated with the discharge pipe 712-2. Although both of the discharge pipes 712 are shown in FIG. 7 as including expansion members 736-1 and 736-2, in some embodiments only one of the discharge pipes 712 may include an expansion member 736.

The pump system 700 may also include at least one walkway 764 allowing personnel to access the pump support 708 as well as the length of the discharge pipes 712. In the present example, the walkway 764 includes a split portion where the distance between the discharge pipes 712 is too great to access both discharge pipes 712 from a single walkway, and a single portion when the distance is small enough to access both discharge pipes 712 from a single walkway (e.g. between the expansion members 736). In other embodiments, two entirely independent walkways may be provided instead of the walkway 736. Further, the system 700 may include de-icing agitators 768 suspended from any one of, or any combination of, the header barge 744, the pump barges 740, the discharge pipes 712, and the walkway 764.

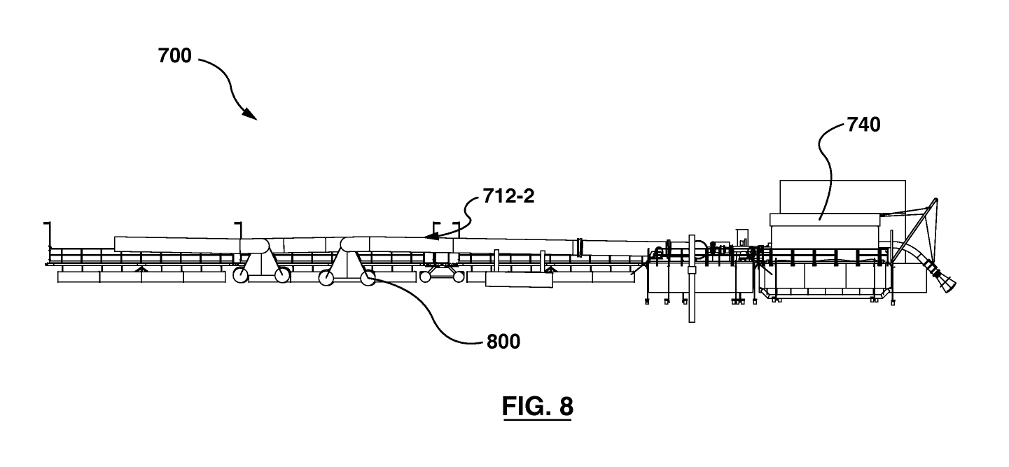

Turning to FIG. 8, a side view of the pump system 700 is shown, in which the discharge pipes 712 are shown to be inclined upwards from the pump barges 740 to the shore, to facilitate draining of the pump system 700. Floats 800 may be employed to assist in maintaining the incline of the discharge pipes 712.

In some examples, the discharge pipe 112 may include more than one expansion member 136. Further, the position of the expansion member 136, or the plurality of expansion members 136, may be varied along the length of the discharge pipe 112. It is presently preferable for the expansion member 136 to be located over the surface of the body of fluid 104, adjacent to the header barge 144 (rather than on shore).

Various advantages to the embodiments described above will now be apparent to those skilled in the art. For example, the ability of the discharge pipe 112 to transition between the expanded and collapsed positions can reduce the stress placed on the discharge pipe 112 itself, as well as on-shore equipment and equipment on the pump support 108 in response to changes in water levels. As a further example, the position of the pump support 108 in a body of fluid (e.g. a tailings pond) may need to be adjusted less frequently to adapt to changing water levels. Still further, when the position of the pump support 108 is adjusted, in some embodiments (e.g. the embodiment shown in FIG. 7) the supply of fluid to the shore from the pump support 108 need not be entirely interrupted during the adjustment. Other advantages will also occur to those skilled in the art.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms such as “left” and right”, “front” and “rear”, “above” and “below” and the like are used as words of convenience to provide reference points and are not to be construed as limiting terms.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

In addition, the foregoing describes only some embodiments of the invention(s), and alterations, modifications, additions and/or changes can be made thereto without departing from the scope and spirit of the disclosed embodiments, the embodiments being illustrative and not restrictive.

Furthermore, invention(s) have described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention(s). Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

We claim:

1. A pump system for use in a body of fluid having a shore, comprising:
a pump support; and
a discharge pipe coupled to the pump support at a first end and to the shore at a second end, the discharge pipe including at least one segment of a first material and at least one segment of a second material, and having an expanded position for increasing a distance between the first and second ends, and a collapsed position for reducing the distance between the first and second ends;
the discharge pipe configured for accommodating lateral forces applied to the pump system by transitioning between the expanded and collapsed positions in response to the lateral forces.

2. The pump system of claim 1, the discharge pipe including a body defining a longitudinal axis, and an expansion member connected to the body, the expansion member having at least one segment that does not contain the longitudinal axis.

3. The pump system of claim 2, the body including the at least one segment of the first material, and the expansion member including the at least one segment of the second material.

4. The pump system of claim 3, the expansion member including first and second segments connected to the body perpendicularly to the longitudinal axis and joined by a third segment parallel to the longitudinal axis.

5. The pump system of claim 4, the first and second segments being made of the second material, and the third segment being made of the first material.

6. The pump system of claim 4, the first and second segments being made of the first material, and the third segment being made of the second material; the body including segments of the second material upstream and downstream of the expansion member.

7. The pump system of claim 3, the body including a further section of the second material.

8. The pump system of claim 1, the pump support further comprising at least one pump barge supporting at least one pump and coupled to a header barge.

9. The pump system of claim 8, the pump support further comprising a header pipe supported by the header barge for connection to the discharge pipe and to the at least one pump.

10. The pump system of claim 9, the pump support further comprising an additional header pipe supported by the header barge, and a plurality of pump barges supporting a plurality of pumps and coupled to the header barge; at least one of the pumps for connection to the header pipe, and at least one other of the pumps for connection to the additional header pipe.

11. The pump system of claim 10, further comprising an additional discharge pipe for connection to the additional header pipe.

12. The pump system of claim 11, the additional discharge pipe further comprising an additional expansion member.

13. The pump system of claim 8, the pump support further comprising at least one mooring element coupled to the header barge.

14. The pump system of claim 13 wherein the at least one mooring element further comprises a spud slideably supported by a spud pocket coupled to the header barge.

15. The pump system of claim 1 wherein the second material has greater flexibility than the first material.

16. The pump system of claim 1 wherein the first material is selected from the group consisting of: steel, aluminum, polyvinyl chloride (PVC), high-density polyethylene (HDPE), and polypropylene.

17. The pump system of claim 1, wherein the second material is selected from the group consisting of: acrylonitrile butadiene styrene (ABS), polyurethane, polytetrafluoroethylene (PTFE), nitrile, neoprene, and rubber.
